(19) United States
(12) Patent Application Publication
(10) Pub. No.: US 2026/0166749 A1
(43) Pub. Date: Jun. 18, 2026

(54) ROBOT AND CONTROL METHOD THEREOF

(71) Applicant: SAMSUNG ELECTRONICS CO., LTD., Suwon-si (KR)

(72) Inventor: Segul ROH, Suwon-si (KR)

(73) Assignee: SAMSUNG ELECTRONICS CO., LTD., Suwon-si (KR)

(21) Appl. No.: 19/393,964

(22) Filed: Nov. 19, 2025

Related U.S. Application Data
(63) Continuation of application No. PCT/KR2025/015372, filed on Sep. 29, 2025.

(30) Foreign Application Priority Data
Dec. 18, 2024 (KR) 10-2024-0190253

(51) Int. Cl. B25J 9/16; B25J 19/02

(52) U.S. Cl. CPC B25J 9/1697; B25J 9/161; B25J 9/163; B25J 9/1661; B25J 19/023

(57) ABSTRACT

A robot and a control method thereof are provided. The robot incudes a camera; memory storing instructions; and at least one processor, wherein the instructions, when executed by the at least one processor individually or collectively, cause the robot to: obtain a first image using the camera; obtain, based on the first image and a user command, a second image showing a result of the robot performing a task corresponding to the user command; obtain action information of the robot for executing the user command by inputting the first image and the second image to a generative artificial intelligence (AI) model; and perform a task corresponding to the user command based on the action information.

### CROSS-REFERENCE TO RELATED APPLICATIONS

This application is a continuation of International Application No. PCT/KR2025/015372 designating the United States, filed on September 29, 2025, in the Korean Intellectual Property Receiving Office and claiming priority to Korean Patent Application No. 10-2024-0190253, filed on December 18, 2024, in the Korean Intellectual Property Office, the disclosures of which are incorporated by reference herein in their entireties.

### BACKGROUND

### 1. Field

The disclosure relates to a robot and a control method thereof, and more particularly, to a robot performing a task based on an image captured by a camera and a user command, and a control method thereof.

### 2. Description of Related Art

In recent years, various types of robots available in industrial fields and public places have been provided as well as household robots such as a cleaning robot.

In particular, such robots are controllable based on various user inputs. For example, a robot may recognize a user voice input through a microphone to obtain a text, and based on the obtained text, perform corresponding tasks. Herein, the robot may obtain action information by inputting the obtained text to a large language model (LLM).

A command for performing a simple task may be given to the robot only by using voice input. However, it is difficult to explain a complex task to the robot only based on voice input. Additionally, in the case in which a user command is input to enable the robot to perform a task, there are limitations of language-based spatial expressions.

The above descriptions may be provided as related art for a better understanding of the subject matter of the present disclosure. Any argument or determination is not raised as to whether any of the descriptions are applicable as prior art associated with the present disclosure.

### SUMMARY

According to an aspect of the disclosure, a robot includes: a camera; memory storing instructions; and at least one processor, wherein the instructions, when executed by the at least one processor individually or collectively, cause the robot to: obtain a first image using the camera; obtain, based on the first image and a user command, a second image showing a result of the robot performing a task corresponding to the user command; obtain action information of the robot for executing the user command by inputting the first image and the second image to a generative artificial intelligence (AI) model; and perform a task corresponding to the user command based on the action information.

The instructions, when executed by the at least one processor individually or collectively, cause the robot to: detect one or more objects in the first image; and based on a user command for moving at least one object among the one or more objects being input, obtain the second image in which the at least one object is moved according to the user command.

The instructions, when executed by the at least one processor individually or collectively, may cause the robot to obtain the second image by performing image inpainting at an initial position of the at least one object after the at least one object in the first image is moved.

The instructions, when executed by the at least one processor individually or collectively, may cause the robot to, based on a user voice for performing the task being input, obtain the action information of the robot by inputting a text query corresponding to the user voice together with the first image and the second image to the generative AI model.

The instructions, when executed by the at least one processor individually or collectively, may cause the robot to, based on the user voice for performing the task being input, generate a pre-set multi-step text query based on the user voice.

The generative AI model may be trained to obtain action information including a sub action goal with respect to each object included in a start image based on a difference between the start image and a target image, and the instructions, when executed by the at least one processor individually or collectively, may cause the robot to obtain the action information including a sub action goal corresponding to the at least one object, by inputting the first image and the second image to a generative AI model.

The instructions, when executed by the at least one processor individually or collectively, may cause the robot to: obtain first pose information of the at least one object in the first image; and obtain second pose information including information on a specific pose taken by the robot to grip the at least one object or information on a position and direction of a grip.

The instructions, when executed by the at least one processor individually or collectively, may cause the robot to obtain information on a sub action plan for moving a first object from among the at least one object based on a first sub action goal corresponding to the first object, the first pose information of the first object and the second pose information.

The instructions, when executed by the at least one processor individually or collectively, may cause the robot to update first pose information of remaining objects from among the at least one object other than the first object after moving the first object based on the information on the sub action plan for moving the first object.

The user command may include a user voice indicating information on the task, and the instructions, when executed by the at least one processor individually or collectively, may cause the robot to: obtain a text query corresponding to the user voice, and obtain the second image by inputting the first image and the text query to a trained neural network model.

According to an aspect of the disclosure, a method of controlling a robot, includes: obtaining a first image using a camera of the robot; obtaining, based on the first image and a user command, a second image showing a result of the robot performing a task corresponding to the user command; obtaining action information of the robot for executing a user command by inputting the first image and the second image to a generative artificial intelligence (AI) model; and performing a task corresponding to the user command based on the action information.

The obtaining the second image may include: detecting one or more objects in the first image; and based on a user command for moving at least one object among the one or more objects being input, obtaining the second image in which the at least one object is moved according to the user command.

The obtaining the second image may include performing image inpainting at an initial position of the at least one object after the at least one object in the first image is moved.

The obtaining the action information may include, based on a user voice for performing the task being input, obtaining the action information of the robot by inputting a text query corresponding to the user voice together with the first image and the second image to the generative AI model.

The obtaining the action information may include, based on the user voice for performing the task being input, generating a pre-set multi-step text query based on the user voice.

The generative AI model may be trained to obtain action information including a sub action goal with respect to each object in a start image, based on a difference between the start image and a target image, and the obtaining the action information may include obtaining the action information including a sub action goal corresponding to the at least one object by inputting the first image and the second image to the generative AI model.

The method may further include: obtaining first pose information of the at least one object in the first image; and obtaining second pose information including information on a specific pose taken by the robot to grip the at least one object or information on a position and direction of a grip.

The obtaining action information may include obtaining information on a sub action plan for moving a first object from among the at least one object based on a first sub action goal corresponding to the first object, the first pose information of the first object and the second pose information.

The method may further include updating first pose information of remaining objects from among the at least one object other than the first object after moving the first object based on the information on the sub action plan for moving the first object.

The user command may include a user voice including information on the task, and the obtaining the second image may include: obtaining a text query corresponding to the user voice; and obtaining the second image by inputting the first image and the text query to a trained neural network model.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of a robot, according to one or more embodiments;

FIG. 2 is a block diagram illustrating a configuration for performing a task of a robot by using an image and a user command, according to one or more embodiments;

FIGS. 3A, 3B, 3C, and 3D are views provided to explain a method of generating a second image based on a first image and a user command, according to one or more embodiments;

FIG. 4 is a view provided to explain a method of generating a multi-step text query, according to one or more embodiments;

FIG. 5 is a view provided to explain a plurality of sub action goals, according to one or more embodiments;

FIG. 6 is a view provided to explain a method of generating a second image by using an image generation model, according to another embodiment; and

FIG. 7 is a flowchart of a method for performing a task of a robot by using an image and a user command, according to one or more embodiments.

### DETAILED DESCRIPTION

Various embodiments set forth herein and terms used herein are not intended to limit technical features of the subject matter of the disclosure to those of specific embodiments thereof, and it is to be understood that the embodiments set forth herein include various modifications, equivalents or alternatives thereof.

In description of the drawings, like reference numerals may be used to indicate like or relevant elements.

Unless explicitly stated otherwise, a singular form corresponding to an item may include a singular form or a plural form thereof.

In the disclosure, each of the phrases such as “A or B,” “at least one of A and B,” “at least one of A or B,” “A, B or C,” “at least one of A, B and C,” and “at least one of A, B or C” may denote including any one of the items listed together in the phrases or all possible combinations thereof. For example, “A or B,” “at least one of A and B,” or “at least one of A or B” may refer to all cases including (1) only A, (2) only B, or (3) both A and B.

In the disclosure, a term such as “1st,” “2nd,” or “first,” or “second” may be used merely to differentiate one element from another, but not to limit the elements in another aspect (e.g., importance or order).

Based on one element (e.g., a first element) referred to as being “coupled with/to or connected with/to” another element (e.g., a second element) with or without the term “functionally” or “communicatively”, it is to be understood that one element may be connected to another element directly (e.g., in a wired manner), in a wireless manner, or through yet another element (e.g., a third element).

In the disclosure, terms such as “include,” or “have” and the like are used to indicate the presence of stated features, numbers, steps, operations, elements, components or a combination thereof, and do not imply exclusion of the presence or addition of one or more different features, numbers, steps, operations, elements, components or a combination thereof.

Based on one element referred to as being “connected with/to,” “coupled with/to,” “supporting,” or “contacting” another element, it is to be understood that one element is connected with/to another element, is coupled with/to another element, supports another element, or contacts another element directly or indirectly through yet another element (e.g., a third element).

Based on one element referred to as being placed “on” another element, it is to be understood that one element contacts another element and that yet another element is present between the two elements.

The term “and/or” denotes including a combination or any of a plurality of relevant elements described.

In a certain situation, the expression “a device configured to…” may denote “being capable of performing” by the device together with another device or other components. For example, the phrase “a processor configured (or set) to perform A, B and C” may mean an exclusive processor (e.g., an embedded processor) for performing the functions, or a generic-purpose processor (e.g., a CPU or an application processor) capable of performing the functions by executing one or more software programs stored in a memory device.

In the embodiments, the term “module” or “unit” may perform at least one function or operation, and be implemented by hardware or software or by a combination of hardware and software. Additionally, a plurality of “modules” or a plurality of “units” may be integrated into at least one module and be implemented as at least one processor excluding a “module” or a “unit” that needs to be implemented by specific hardware.

Various elements and regions in the drawings are schematically illustrated. Accordingly, the technical spirit of the disclosure is not limited by relative sizes or distances illustrated in the accompanying drawings.

Hereafter, embodiments of the disclosure will be described in detail with reference to the accompanying drawings.

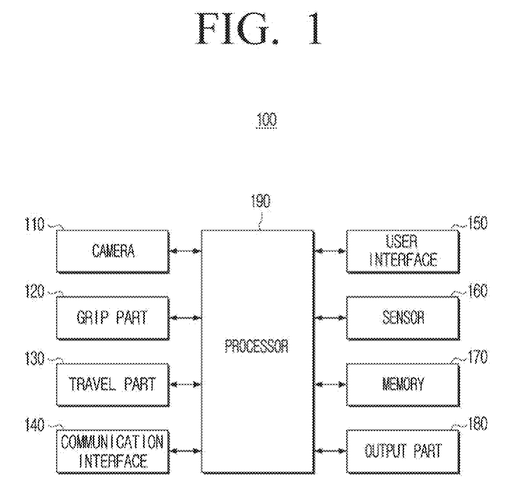

FIG. 1 is a block diagram illustrating a configuration of a robot, according to one or more embodiments. As illustrated in FIG. 1, a robot 100 may include a camera 110, a grip part 120, a travel part 130, a communication interface 140, a user interface 150, a sensor 160, memory 170, an output part 180 and at least one processor 190 (also referred to as “the processor”). Herein, the robot 100 may be a humanoid robot mimicking human behavior, but embodiments are not limited thereto. Additionally, the robot 100 may be implemented as a cleaning robot, a serving robot, a guide robot and the like for various purposes. The

configuration in FIG. 1 is illustrated merely as one example, and depending on the type of a robot 100, various elements may certainly be added or omitted.

The camera 110 may obtain an image by capturing surroundings of the robot 100. For example, the camera 110 may capture an area in the front of the robot 100. As one example, the camera 110 may include a three-dimensional image sensor (e.g., a depth camera). The three-dimensional image sensor may capture surroundings of the robot 100 and generate three-dimensional space information in association with the surroundings of the robot 100. For example, the three-dimensional image sensor may generate an image (e.g., a depth image) including three-dimensional distance information by sensing a distance to an object around the robot 100. The image may include depth information based on each pixel. Accordingly, data obtained by the three-dimensional image sensor may include three-dimensional coordinate information (e.g., a (x, y, z) coordinate value) of points that are searched by the three-dimensional image sensor based on a scan. For example, the three-dimensional image sensor may be implemented based on various methods such as a stereo vision method, an infrared (IR) method, a time of flight (TOF) method and the like. Herein, the image sensor may also be referred to as various terms such as a camera and the like.

In particular, the camera 110 may obtain a first image by capturing surroundings of the robot 100. Herein, the first image may be referred to as various terms such as a start image, an original image, a basic image and the like.

The grip part 120, as an element for gripping an object or performing a manipulation, may be disposed at the end of a robot arm (a manipulator). In particular, the grip part 120 may include a drive part providing power of moving the grip part 120 or closing or opening the grip part 120, and a manipulation part actually gripping an object or performing a manipulation. The grip part 120 may be implemented as a mechanical griper, but embodiments are not limited thereto, and may be implemented in various different forms such as a vacuum gripper, a magnetic gripper, a multi-finger gripper and the like.

The travel part 130 is an element for moving the robot 100. In particular, the travel part 130 may include at least one wheel, at least one motor for rotating the wheel, a motor driver for controlling the at least one motor, a brake for stopping a rotating wheel and the like. The processor 190 may control the travel part 130, to perform various travel operations of moving and stopping the robot 100, controlling a speed, changing a direction and an angular velocity, and the like.

In particular, the processor 190 may obtain information on an action plan of the robot 100 obtained based on a first image and a user command, and control the grip part 120 and the travel part 130 based on the information on the action plan, to perform a task corresponding to the user command.

The communication interface 140 may communicate with an external device or a charging station through a network. The communication interface 140 may include a wireless communication module or a wired communication module. The communication module may be implemented as at least one hardware chip.

The network may include a wide area network (WAN) such as the Internet and the like, a local area network (LAN) formed around an access point (AP), a short distance wireless network without an access point (AP). The short distance wireless network may include Bluetooth (BluetoothTM, IEEE 802.15.1), Zigbee (Zigbee, IEEE 802.15.4), Wi-Fi Direct, Near Field Communication (NFC), Z-Wave, and the like, but not be limited thereto.

According to one or more embodiments, the communication interface 140 may communicate with an external device through an access point (AP). For example, the access point (AP) may connect a local area network (LAN) to which the robot 100 is connected, to a wide area network (WAN) to which a server is connected. The robot 100 may be connected to the server through the wide area network WAN. The access point (AP) may communicate with the robot 100 by using wireless communication such as Wi-Fi (Wi-FiTM, IEEE 802.11), Bluetooth, Zigbee and the like, and may be connected to a wide area network (WAN) by using wired communication.

According to one or more embodiments, the robot 100 may be directly connected with an external device without an access point (AP). For example, the communication interface 140 may communicate with an external device through a long distance wireless network or a short distance wireless network. The robot 100 may be connected with a home appliance, a mobile device and the like through a short distance wireless network (e.g., Bluetooth, Wi-Fi DIRECT). Additionally, the robot 100 may be connected with an external device through a wide area network (WAN) by using a long distance wireless network (e.g., a cellular communication module).

The user interface 150 may include various types of input devices configured to receive a user input. For example, the user interface 150 may include a physical button. At this time, the physical button may include a function key, a direction key (e.g., a four-direction key) or a dial button. Additionally, the user interface 150 may receive a user input based on a non-contact method. Specifically, the user interface 150 may receive a user gesture, and perform an operation corresponding to the received user gesture. Herein, the user interface 150 may obtain information on the user gesture through the camera 110. Additionally, the user interface 150 may receive a user input based on a touch method. For example, a manipulation interface 115 may receive a user input through a touch sensor.

The robot 100 may receive a user input based on various methods in addition to the above-described user interface 150. In various embodiments, the robot 100 may receive a user input through an external remote control device. Herein, the external remote control device may be a remote control device (e.g., a control device exclusive for the robot 100)

corresponding to the robot 100 or a mobile communication device (e.g., a smartphone or a wearable device) of the user. In various embodiments, the robot 100 may receive a user voice by using a microphone. Herein, the microphone may be provided in the robot 100, but embodiments are not limited thereto, and the microphone may be placed outside the robot 100 (e.g., in a remote control device) and communicably connected with the robot 100.

The sensor 160 is an element for detecting information on the robot 100 and surroundings of the robot 100. In particular, The sensor 160 may include a plurality of sensors, the plurality of sensors may detect the structure of a specific space or an object in the specific space. The object may include, for example, a wall and an obstacle in an indoor space. The obstacle may include various items present in a specific space such as furniture, a home appliance, a remote controller, a key, a person, an animal and the like. Additionally, information obtained by the plurality of sensors may be used to generate a map of the indoor space.

The sensor 160 may include a light detection and ranging (LiDAR) sensor, an obstacle sensor and an inertial measurement unit (IMU) sensor. Herein, the LiDAR sensor outputs a laser in a 360-degree direction, and based on receiving the laser reflected from an object, analyze a difference in time taken for the laser to reflect and return from the object and the intensity of a received laser signal and the like, to obtain geometry information on an indoor space. The geometry information may include the position, distance, direction and the like of an object. The LiDAR sensor may provide the obtained geometry information to the processor 190. The obstacle sensor may sense an obstacle around the robot 100. For example, the obstacle sensor may include at least one of an ultrasonic sensor, an infrared sensor, a radio frequency (RF) sensor, a time of flight (ToF) sensor, and a position sensitive device (PSD) sensor. The obstacle sensor may sense an obstacle present in front of, behind or beside the robot 100 or on a movement path of the robot 100. The obstacle sensor may provide sensed obstacle

information to the processor 190. Herein, the obstacle sensor may be referred to as various terms such as a travel-associated sensor and the like. The IMU sensor is a sensor for sensing the pose, movement, acceleration of the robot 100. Herein, the IMU sensor may include a gyro sensor and an acceleration sensor and the like. The gyro sensor may sense a rotation direction and a rotation angle of the robot 100. The acceleration sensor may sense a change in the speed of the robot 100. In one or more embodiments, the IMU sensor may further include a geomagnetic sensor and the like. In particular, the IMU sensor may sense a degree to which the robot 100 is moved, a pose of the robot 100, and the like, based on force applied from the outside.

The memory 170 may store an operating system (OS) for controlling overall operations of the elements of the robot 100 and instructions or data in association with the elements of the robot 100. In particular, the memory 170 may include one or more storage media (or one or more storage devices). For example, the memory 170 may include a memory assembly including one or more storage media. For example, the one or more storage media may include permanent memory (e.g., non-volatile memory) such as hard drive, flash memory, read-only memory (ROM), and semi-permanent memory (e.g., volatile memory) such as random access memory (RAM), any other suitable type of storage (or a storage assembly) or any combination thereof. The memory 170 may be fixedly embedded in the robot 100, or may be integrated with one or more suitable types of elements (e.g., a subscriber identity module (SIM) card and/or a secure digital (SD) card) that are repeatedly inserted into the robot 100 or removable from the robot 100.

For example, the memory 170 may store one or more software applications such as an operating system (or a system) software application, a firmware software application, a driver software application, a plug-in (e.g., add-in, add-on and/or applet) software application, and/ or any other suitable software applications. For example, the one or more software applications may include instructions executable by the processor 190. For example, the memory 170 may store instructions callable by an application programming interface (API). For example, the memory 170 may store instructions in a library.

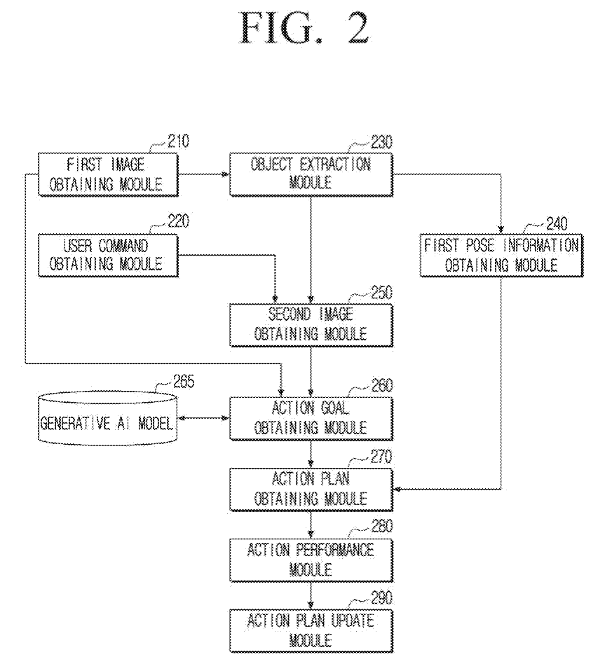

In one or more embodiments, the memory 170, as illustrated in FIG. 2, may include one or modules 210-290 for performing a task of the robot 200 based on an image and a user command. However, this is described merely as one example, and at least one of the modules 210-290 for performing a task of the robot 100 may be stored in an external device.

In one or more embodiments, the memory 170 may store a generative artificial intelligence (AI) model 265 for obtaining action information of the robot 100 based on a first image and a second image. Herein, the generative AI model 265 may be trained to obtain action information including a sub action goal of each object included in a start image based on a difference between the start image and a target image. Additionally, the memory 170 may store an image generation model 630 capable of obtaining a second image based on a first image and a user input. However, this is merely one example, and at least one of the generative AI model 265 or the image generation model 630 may be stored in an external server.

The output part 180 may output information in association with a state or a task of the robot 100. For example, the output part 180 may include a display, a speaker, a light emitting diode (LED) and the like.

In one or more embodiments, the output part 180 may provide information in association with a task of the robot 100. Additionally, the output part 180 may provide a UI for generating a second image from a first image.

The processor 190 control entire operations of the robot 100. Specifically, the processor 190 may be connected with the elements of the robot 100 and may control the entire operations of the robot 100. For example, the processor 190 may be connected with the camera 110, the grip part 120, the travel part 130, the communication interface 140, the user interface 150, the sensor 160, the memory 170 and the output part 180, to control the robot 100. The processor 190 may be comprised of one or a plurality of processors.

The processor 190 may perform the operations of the robot 100 according to one or more embodiments by executing one or more instructions stored in the memory 170.

The processor 190 may include one or more of a central processing unit (CPU), a graphics processing unit (GPU), an accelerated processing unit (APU), a many integrated core (MIC), a digital signal processor (DSP), a neural processing unit (NPU), an hardware accelerator or a machine learning accelerator. The processor 190 may control one of the other elements of the robot 100 or any combination thereof, and perform an operation in association with communication or perform data processing. The processor 190 may execute one or more programs or instructions stored in the memory 170. For example, the processor 190 may perform a method according to an embodiment, by executing one or more instructions stored in the memory 170.

In the case where the method according to one or more embodiments includes a plurality of operations, the plurality of operations may be performed by one processor, or by multiple processors. For example, in the case where a first operation, a second operation, and a third operation are performed based on the method according to one or more embodiments, the first operation, the second operation and the third operation may all be performed by a first processor, or the first operation and the second operation may be performed by the first processor (e.g., a generic-purpose processor), while the third operation may be performed by a second processor (e.g., an AI-exclusive processor).

The processor 190 may be implemented as a single core processor including one core, or one or more multicore processors including multiple cores (e.g., homogeneous multi cores or heterogeneous multi cores). In the case where the processor 190 is implemented as a multicore processor, each of the multiple cores included in the multicore processor may include processor internal memory such as cache memory, and on-chip memory, and common cache shared by the multiple cores may be included in the multicore processor. Additionally, each of the multiple cores (or part of the multiple cores) included in the multicore processor may read and perform a program instruction for implementing the method according to one or more embodiments independently, or in the way that all (or part) of the multiple cores are associated.

In the case where the method according to one or more embodiments includes a plurality of operations, the plurality of operations may be performed by one of the multiple cores included in the multicore processor, or by the multiple cores included in the multicore processor. For example, in the case where a first operation, a second operation, and a third operation are performed based on the method according to one or more embodiments, the first operation, the second operation and the third operation may all be performed by a first core included in the multicore processor, or the first operation and the second operation may be performed by the first core included in the multicore processor, while the third operation may be performed by a second core included in the multicore processor.

In the embodiments, the processor may denote a system on a chip (SoC) where one or more processors and other electronic components are integrated, a single core processor, a multicore processor, or a core included in a single core processor or a multicore processor, and herein, the core may be implemented as a CPU, a GPU, an APU, an MIC, a DSP, an NPU, a hardware accelerator, or a machine learning accelerator and the like, but the embodiment thereof may not be limited thereto.

According to one or more embodiments, the processor 190 may obtain a first image through the camera 110, and based on the first image and a user command, obtain a second image showing a result of the robot performing a task corresponding to the user command, input the first image and the second image to a generative AI model and obtain action information of the robot 100 for performing the user command, and based on the action information, perform the task corresponding to the user command.

In one or more embodiments, the processor 190 may detect one or more objects or a plurality of objects included in the first image, and in the case where a user command for moving at least one object of the plurality of objects is input, may obtain a second image where the at least one object is moved according to the user command.

In one or more embodiments, the processor 190 may perform image inpainting at the initial position of the at least one object after the at least one object in the first image is moved.

In one or more embodiments, in the case where a user voice for performing a task is input, the processor 190 may input, to a generative AI model, a text query corresponding to the user voice together with the first image and the second image, and obtain action information of the robot.

In one or more embodiments, in the case where a user voice for performing a task is input, the processor 190 may generate a pre-set multi-step text query based on the user voice.

In one or more embodiments, the processor 190 may input the first image and the second image to the generative AI model and obtain action information including a sub action goal corresponding respectively to the at least one object.

In one or more embodiments, the processor 190 may obtain first pose information on the at least one object through the first image, and obtain second pose information including information on a specific pose taken by the robot 100 to grip the at least one object or information on the position and direction of a grip.

In one or more embodiments, the processor 190 may obtain information on a sub action plan for moving a first object out of the at least one object based on a first sub action goal corresponding to the first object, the first pose information of the first object, and the second pose information.

In one or more embodiments, the processor 190 may move the object based on the information on the sub action plan for moving the first object and then update first pose information of the remaining objects excluding the first object out of the at least one object.

In one or more embodiments, the processor 190 may obtain a text query corresponding to a user voice including information on a task, and may input the first image and the text query to a trained neural network model (e.g., an image generation model) and obtain a second image.

FIG. 2 is a block diagram illustrating a configuration for performing a task of a robot by using an image and a user command, according to one or more embodiments. As illustrated in FIG. 2, the robot 100 may include a first image obtaining module 210, a user command obtaining module 220, an object extraction module 230, a first pose information obtaining module 240, a second image obtaining module 250, an action goal obtaining module 260, an action plan obtaining module 270, an action performance module 280 and an action plan update module 290. The configuration in FIG. 2 is merely one example, and certainly, a new module may be added or an existing module may be omitted. Additionally, the configuration illustrated in FIG. 2 may be implemented by software but described merely as one example, and the configuration may be implemented based on a combination of software and hardware. Further, part of the elements illustrated in FIG. 2 may be included in an external device (e.g., a cloud server and the like) rather than the robot 100.

The first image obtaining module 210 may obtain a first image through the camera 110. Herein, the first image may also be referred to as various terms such as a start image, a basic image, an original image and the like. In the first image, at least one object may be included. For example, the first image obtaining module 210 may obtain a first image 310 as illustrated in FIG. 1.

In one or more embodiments, the first image obtaining module 210 may obtain a first image of a surrounding environment of the robot 100 through at least one camera 110 provided in a pre-set area (e.g., the head area of and the like) of the robot 100. In one or more embodiments, the first image obtaining module 210 may obtain a first image of which surroundings of the robot 100 are captured from a camera outside the robot 100.

The user command obtaining module 220 may obtain a user command. Herein, the user command is a user command for controlling the robot 100, and the user command obtaining module may obtain various types of user commands. In one or more embodiments, the user command obtaining module 220 may obtain a user touch input for moving an object include in the first image. In one or more embodiments, the user command obtaining module 220 may obtain a user voice input including information on a task to be performed by the robot 100, from the first image. However, this is merely one example, and the user command obtaining module 220 may receive an input of various types of user commands from various sources.

The object extraction module 230 may extract an object form the first image. Specifically, the object extraction module 230 may perform a transition to a gray scale, removal of a noise, histogram equalization and the like that are examples of pre-processing of the first image. The object extraction module 230 may detect an edge that is a boundary of the object by using an algorithm such as canny edge detection and the like. The object extraction module 230 may divide the first image into a plurality of areas and separate an area of interest. The object extraction module 230 may perform contour detection of finding the edge of the object based on edge information. The object extraction module 230 may extract the object and perform post-processing.

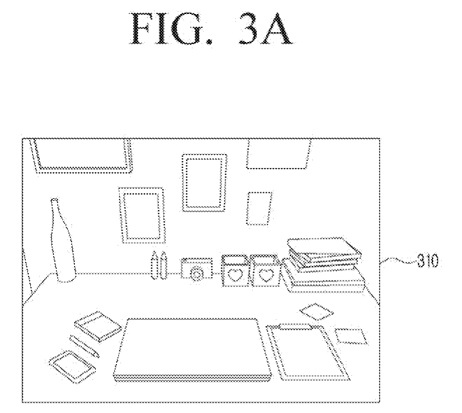

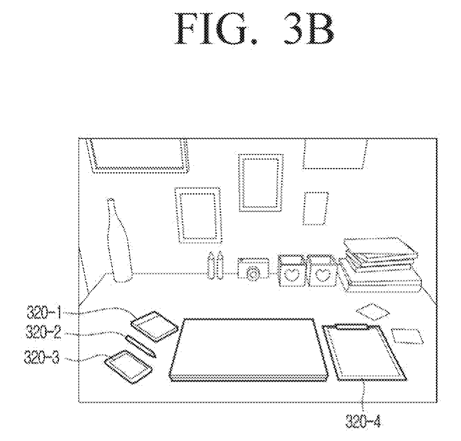

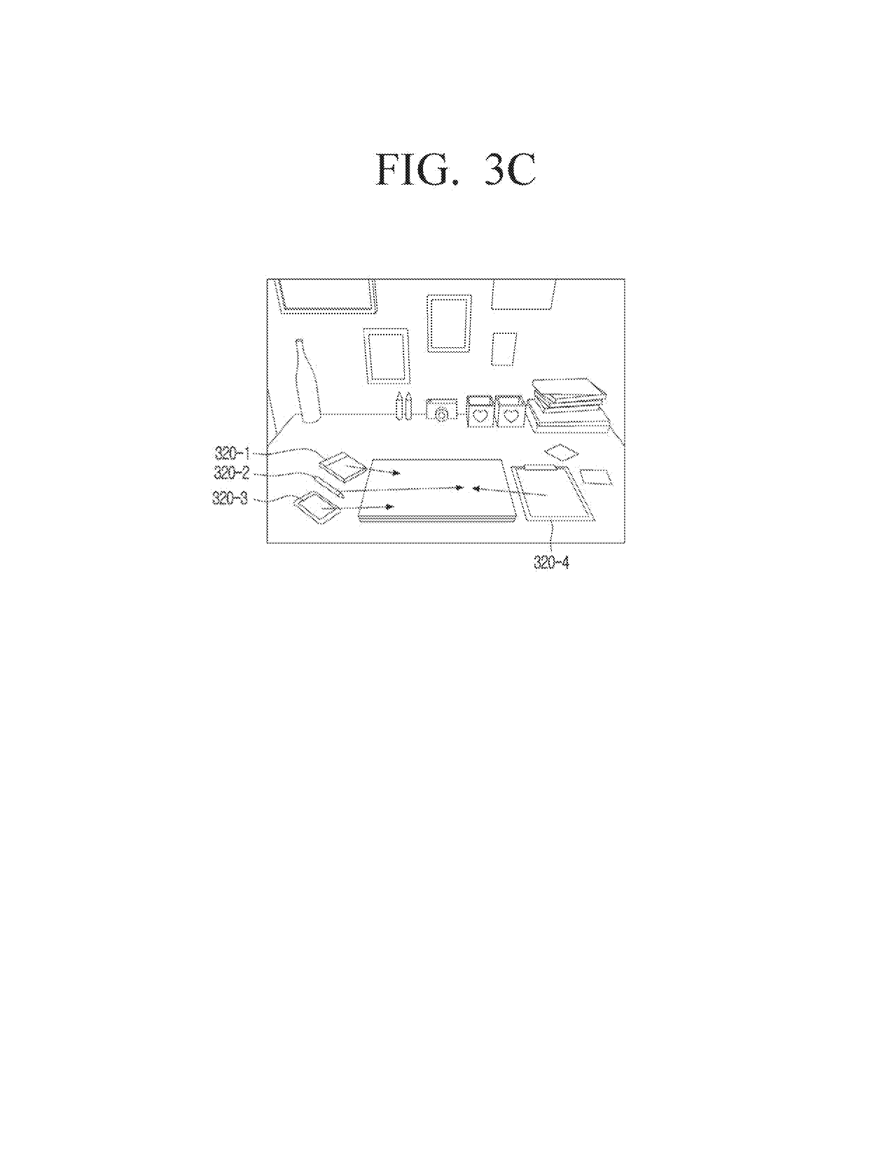

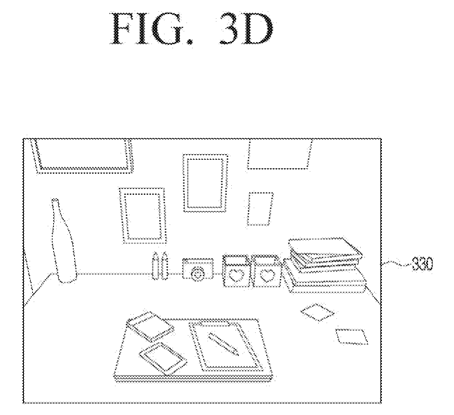

In particular, the object extraction module 230 may display the edge of the extracted object in a thick manner after extracting the object. For example, the object extraction module 230, as illustrated in FIG. 3B, may extract first, second, third, and fourth objects 320-1, 320-2, 320-3, and 320-4 included in the first image, and display the edges of the extracted first to fourth objects 320-1 to 320-4 in a thick manner. However, this is merely one example, and the object extraction module 230 may provide information on the extraction of the object based on an adjustment of the color, brightness of the extracted object or a flicker.

In one or more embodiments, the object extraction module 230 may crop the extracted object, and input an image of the cropped object to an object recognition model to obtain information on the extracted object. For example, the object extraction module 230 may input the first to fourth objects 320-1 to 320-4 as illustrated in FIG. 3B to the object recognition model, and obtain type information on each of the first to fourth objects 320-1 to 320-4.

The first pose information obtaining module 240 may obtain pose information on a detected object. Herein, the pose information may be information indicating the position and pose of an object. Herein, position information of an object, as information indicating where the object is in an image, may be represented by x,y coordinates in the case of a two-dimensional image. Pose information of an object, as information indicating which direction is faced by the object in an image, may be represented by a rotation angle at which the object is rotated with respect to a specific axis (x,y axes). In particular, the first pose information obtaining module 240 may obtain pose information based on a key point (e.g., an edge and the like) of an object.

The second image obtaining module 250 may obtain a second image based on a user command and the first image. Herein, the second image, as an image showing a result of the robot 100 performing a task corresponding to a user command, may be referred to as various terms such as an end image, a target image, a task image and the like.

In one or more embodiments, the robot 100 may display an image including information on the object extracted by the object extraction module 230. For example, the robot 100, as illustrated in FIG. 3B, may display a first image where the edges of the extracted first to fourth objects 320-1 to 320-4 are displayed in a thick manner. Additionally, in the case where a user command corresponding to touching one of the first to fourth objects 320-1 to 320-4 displayed on the first image and then dragging the object is input, the second image obtaining module 250 may move the object touched according to the user command. For example, the user command obtaining module 220, as illustrated in FIG. 3C, may obtain a user command for moving the first to fourth objects 320-1 to 320-4 onto a table. Additionally, the second image obtaining module 250 may move the first to fourth objects 320-1 to 320-4 onto the table according to the user command. Further, the second image obtaining module 250 may perform image inpainting at the initial position of at least one object after the object in the first image is moved. Herein, the inpainting may denote restoring a damaged or deficient portion in an image, and the second image obtaining module 250 may fill a vacant space based on inpainting after the object in the first image is moved. At this time, the second image obtaining module 250 may perform the inpainting operation by using trained neural network models (e.g., diffusion-based models), patch-based models or generative adversarial networks (GANs) and the like. By doing so, the second image obtaining module 250, as illustrated in FIG. 3D, may obtain the second image showing a result of the performance of the robot 100. In one or more embodiments, the robot 100 may obtain the second image by inputting the first image and information on a user voice (e.g., text information) to a trained image generation model. Herein, the image generation model may be a generative AI model trained to obtain the second image of which the first image is corrected based on the first image and the text information. Detailed description in relation to this is provided hereafter with reference to the drawings.

According to one or more embodiments, the robot 100 may obtain one of images stored therein as the second image, or obtain the second image from a user terminal device. Specifically, the robot 100 may obtain an image selected by the user among a plurality of images stored therein as the second image. Additionally, the robot 100 may receive the second image selected by the user from the user terminal device.

According to one or more embodiments, the robot 100 may obtain the second image that is image-edited by the user from the user terminal. Specifically, the robot 100 may obtain the second image that is generated by moving/changing the captured first image based on a cut-out.

The action goal obtaining module 260 may obtain an action goal of the robot 100 based on the first image and the second image. Herein, the action goal may be a goal indicating a task that the user wants to perform based on an action of the robot 100. Herein, the action goal may include a sub action goal corresponding respectively to a plurality of objects.

In one or more embodiments, the action goal obtaining module 260 may obtain an action goal by inputting the first image and the second image to a trained generative AI model 265. Herein, the generative AI model 265 may be an artificial intelligence model generating new contents based on input data, and in one or more embodiments, the generative AI model 265, as a model trained to obtain an action goal of the robot 100 based on a difference in the two mages, may be referred to as an action goal obtaining model, a multi modal model and the like. Accordingly, the action goal obtaining module 260 may obtain an action goal obtained based on a difference between the first image and the second image by inputting the first image and the second image to the generative AI model 265. For example, the action goal obtaining module 260 may obtain an action goal including information on the movement of the first to fourth objects 320-1 to 320-4 included in the first image by inputting the first image 310 illustrated in FIG. 3A and the second image 330 illustrated in FIG. 3D to the generative AI model 265.

Additionally, in the case where a user voice for performing a task input through the user command obtaining module 220 is input, the action goal obtaining module 260 may obtain action information of the robot by inputting a text query corresponding to the user voice together with the first image and the second image to the generative AI model. Herein, the text query may denote an input for starting an interaction with the generative AI model 265. The text query may be a text input or a voice input including one or more texts and/or one or more sentences. In one or more embodiments, the text query may include a natural language text. The natural language text may include various types of information, such as a context, intent, a task, constraints and the like that is used by the generative AI model to generate a response to a user inquiry or control the robot 100. The text query may be replaced with terms such as a prompt, an input, a user input, an input phrase, a message and the like.

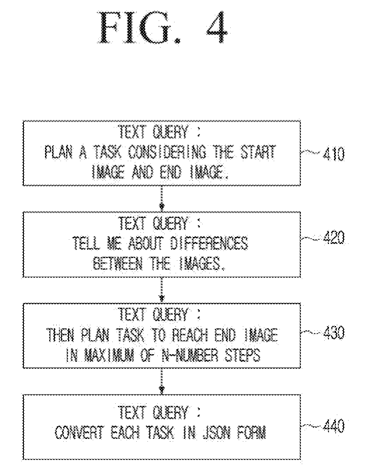

In one or more embodiments, in the case where a user voice is input to perform a task through the user command obtaining module 220, the action goal obtaining module 260 may generate a pre-set multi-step text query based on the user voice. Herein, the pre-set multi-step text query may be stored previously, but embodiments are not limited thereto, and may be obtained through a trained neural network model. For example, in the case where a user voice 410 “Plan a task considering the start image and end image” is input as illustrated in FIG. 4, the action goal obtaining module 260 may obtain a first text query 420 “Tell me about differences between the images,” based on the user voice 410. Additionally, the action goal obtaining module 260 may obtain a second text query 430 “Then, plan a task to achieve an end image in a maximum of N-number steps,” based on the first text query 420. Additionally, the action goal obtaining module 260 may obtain a third text query 440 such as “Convert each task in a JSON form,” based on the second text query 430. Herein, the multi-step text query may be sequentially generated, but not embodiments are limited thereto, and certainly, the multi-step text query may be generated at the same time based on the user voice. By doing so, the action goal obtaining module 260 may obtain a more accurate action goal by using the generative AI model 265.

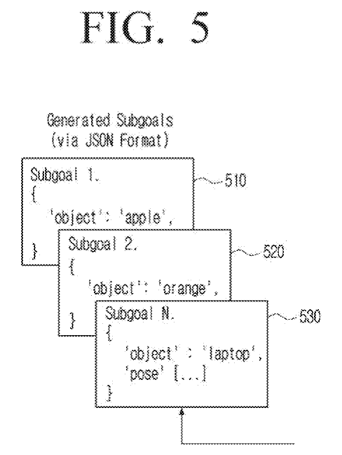

In one or more embodiments, the action goal obtaining module 260 may obtain a sub action goal corresponding respectively to a plurality of objects. Herein, the sub action goal may be a goal indicating a task of the robot 100 with respect to an object. For example, the action goal obtaining module 260, as illustrated in FIG. 5, may obtain a first sub action goal 510 corresponding to an apple, a second sub action goal 520 corresponding to an orange, and a third sub action goal 530 corresponding to a laptop.

Herein, the action goal obtaining module 260 may determine the order of executing sub action goals based on the difference between the first image and the second image. In one or more embodiments, in the case where a whiteboard 320-4 is placed under a pencil 320-2 as illustrated in the second image 330 of FIG. 3D, the action goal obtaining module 260 may perform a sub action goal corresponding to the white board 320-4 and then perform a sub action goal corresponding to the pencil 320-2. Alternatively, the action goal obtaining module 260 may determine the order of executing sub action goals based on the importance, sizes, or distances of objects. For example, the action goal obtaining module 260 may set the order of execution first based on an object of high importance, an object of a big size or an object within a short distance. However, the order is described merely as one example, and embodiments are not limited thereto.

The action plan obtaining module 270 may obtain information on an action plan based on first pose information, second pose information and an action goal. Herein, the action plan may be a specific execution plan designed for the robot to achieve an action goal, and the robot 100 may generate the action plan based on sensor data, an algorithm, a control system and the like.

In one or more embodiments, the action plan obtaining module 270 may obtain information on a sub action plan for moving a first object out of at least one object based on a first sub action goal corresponding to the first object, the first pose information of the first object and the second pose information. Specifically, the action plan obtaining module 270 may obtain the first pose information corresponding to the first object from a first pose information obtaining module 240. Additionally, the action plan obtaining module 270 may obtain second pose information including information on a specific pose taken by the robot 100 to grip an object or information on the position and direction of a grip. Additionally, the robot 100 may obtain a first sub action goal corresponding to the first object from the action goal obtaining module 260. Further, the robot 100 may obtain a first sub action plan with respect to the first object. For example, in the case where the first sub action goal “Move the first object onto the table” is obtained, the action plan obtaining module 270 may obtain the first sub action plan “Calculate an optimal path -> Move to an area where the first object is placed ->Grip the first object by using the grip part 120 -> Move to the table-> Place the object onto the table”, which corresponds to the first object, based on the first pose information, the second pose information and the first sub action goal corresponding to the first object.

The action performance module 280 may perform an action based on an action plan or a sub-action plan for the object. In one or more embodiments, the action performance module 280 may perform an action based on a first sub-action plan corresponding to a first object.

The action plan update module 290 may perform a task with respect to an object, and based on a result of the performance, update an action plan with respect to the remaining objects. Specifically, the first pose information obtaining module 240 may move the object based on information on the sub action plan for moving the first object and then, out of the at least one object, update first pose information of the remaining objects excluding the first object. That is, since the positions or poses of the remaining objects may be changed after the first object is moved, the first pose information obtaining module 240 may update the first pose information on the positions or poses of the remaining objects. The action plan update module 290 may update sub action plans for the remaining objects based on the updated first pose information and second pose information of the remaining objects, and sub action plans with respect to the remaining objects. In this way, the action plan update module 290 may update the action plans with respect to the remaining objects each time an action plan with respect to an object is performed.

In the above-described embodiment, obtaining the second image based on the user input on the first image is described, but described merely as one example, and the second image may be obtained by using a trained image generation model.

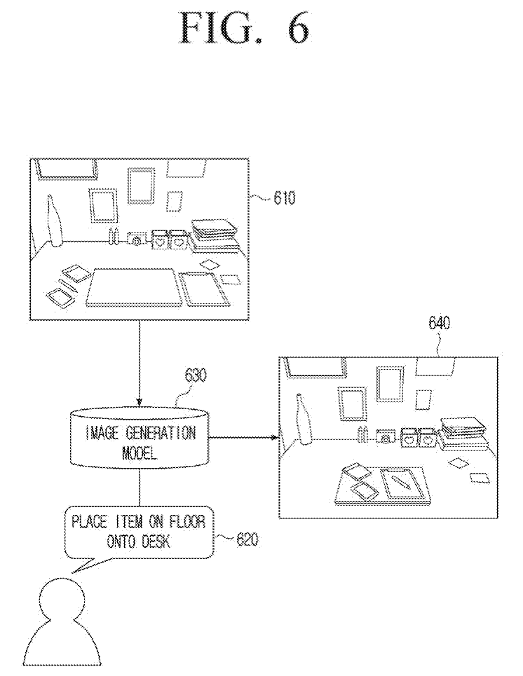

FIG. 6 is a view provided to explain a method of generating a second image by using an image generation model, according to another embodiment.

The robot 100 may obtain a first image 610 through the camera 110. For example, the robot 100 may obtain the first image 610 including a plurality of objects as illustrated in FIG. 6.

The robot 100 may obtain a user voice 620 including information on a task. The robot 100 may obtain a text query based on voice recognition of the user voice. For example, the robot 100, as illustrated in FIG. 6, may obtain a text query corresponding to the user voice 620, such as “Place the item on the floor onto the desk,” uttered by the user.

The robot 100 may obtain a second image by inputting the first image 610 and the text query to a trained image generation model 630. Herein, as a neural network model trained to edit a first image to a second image based on a text, the image generation model 630, for example, may be implemented as various types of neural network models such as a generative adversarial network (GAN)-based model, a multi-modal transformation model, a text-based image edit model and the like. For example, the robot 100 may obtain a second image 640 in which the item having been placed on the floor is on the desk by inputting the first image 610 and the text query to the trained image generation model 630 as illustrated in FIG. 6.

The robot 100 may obtain action information of the robot 100 for executing a user command (or a user voice 620) by inputting the first image 610 and the second image 640 to a generative AI model 265. Performing a task corresponding to a user command by the robot 100 based on action information is described with reference to FIG. 2, and accordingly, description in relation to this is avoided.

In the above-described embodiment, implementing the image generation model 630 and the generative AI model 265 separately is described, but is described merely as one example, and the image generation model 630 and the generative AI model 265 may be implemented as one integrated model. In the case where the image generation model 630 and the generative AI model 265 are implemented as one integrated generative AI model, the integrated generative AI model may be a neural network model trained to obtain an action goal based on an input of the first image and the text query.

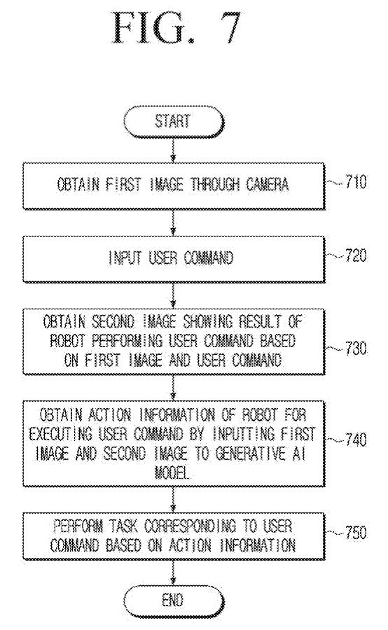

FIG. 7 is a flowchart of a method for performing a task of a robot by using an image and a user command, according to one or more embodiments.

In the embodiment described hereafter, each of the operations may be performed sequentially, but not necessarily performed sequentially. For example, the order of each of the operations may be changed, and at least two of the operations may be performed in parallel.

In one or more embodiments, it may be understood that operations 710 to 750 are performed by at least one processor (e.g., at least one processor 190 of FIG. 1) of an electronic apparatus (e.g., a robot 100 of FIG. 1).

A robot 100 obtains a first image through a camera 110 (710). Herein, the first image, as a start image, may include at least one object.

The robot 100 may receive an input of a user command (720). Herein, the user command, as a command for the robot 100 to perform a task, may be a user touch input or a user voice input.

The robot 100 obtains a second image showing a result of the robot 100 performing the task corresponding to the user command based on the first image and the user command (730). In one or more embodiments, the robot 100 may detect a plurality of objects included in the first image. Additionally, in the case where a user command for moving at least one object of the plurality of objects is input, the robot 100 may obtain a second image in which the at least one object is moved according to the user command. Herein, the robot 100 may perform image inpainting at the initial position of the at least one object after the at least one object in the first image is moved.

In one or more embodiments, the robot 100 may obtain a text query corresponding to a user voice, and obtain a second image by inputting the first image and the text query to a trained neural network model.

The robot 100 obtains action information of the robot 100 for executing the user command by inputting the first image and the second image to a generative AI model (740). Herein, the generative AI model may be a neural network model trained to obtain action information including a sub action goal of each object included in a start image based on a difference between the start image and a target image.

In one or more embodiments, in the case where the user voice for performing a task is input, the robot 100 may obtain action information of the robot by inputting the text query corresponding to the user voice together with the first image and the second image to the generative AI model. Herein, the robot 100 may generate a pre-set multi-step text query based on the user voice.

In one or more embodiments, the robot 100 may obtain action information including a sub action goal corresponding respectively to the at least one object by inputting the first image and the second image to the generative AI model.

In one or more embodiments, the robot 100 may obtain first pose information on the at least one object through the first image, and may obtain second pose information including information on a specific pose taken by the robot 100 to grip the at least one object or on the position and direction of a grip. Additionally, the robot 100 may obtain information on a sub action plan for moving a first object out of the at least one object, based on a first sub action goal corresponding to the first object, the first pose information of the first object and the second pose information.

The robot 100 performs the task corresponding to the user command based on the action information (750).

In one or more embodiments, the robot 100 may update first pose information of the remaining objects expect for the first object out of the at least one object after moving the object based on the information on the sub action plan for moving the first object. Additionally, the robot 100 may update sub action plans for the remaining objects based on the updated first pose information.

The embodiments described above may be implemented with software including instructions stored in a storage medium readable by a machine (e.g., a computer). The machine, as a device capable of calling the stored instructions from the storage medium and operating according to the called instructions, may include the robot according to the disclosed embodiments. Based on executing instructions by a processor, the processor may perform functions corresponding to the instructions directly or by using other elements under the control of the processor. The instructions may include a code generated or executed by a compiler or an interpreter. The machine-readable storage medium may be provided in the form of a non-transitory storage medium. Herein, the term “non-transitory” only means that the storage medium is not a signal and is tangible while the term does not differentiate semi-permanent or temporary storage of data in the storage medium.

Additionally, according to the embodiments set forth herein, the method may be provided in a computer program product. The computer program product may be exchanged between a seller and a purchaser as a commodity. The computer program product may be distributed in the form of a machine-readable storage medium (e.g., compact disc read only memory (CD-ROM)), or distributed online through an application store (e.g., Play StoreTM). In the case of online distribution, at least part of the computer program product may be stored at least temporarily, or generated temporarily in a storage medium such as a manufacturer’s server, a server of an application store, or memory of a relay server.

Additionally, the embodiments described above may be implemented in a recording medium readable by a computer or a device similar to a computer by using software, hardware or a combination thereof. In some cases, the embodiments set forth herein may be implemented as a processor itself. In the case of software implementation, the embodiments such as steps and functions described herein may be implemented as separate software. Each software may perform one or more functions and operations set forth herein.

Computer instructions for performing processing operations of a device according to the embodiments described above may be stored in a non-transitory computer-readable medium. The computer instructions stored in the non-transitory computer-readable medium, when executed by a processor of a specific device, cause the specific device to perform the processing operations in the device according to the embodiments described above. The non-transitory computer-readable medium denotes a medium that stores data semi-permanently and is readable by a machine, rather than a medium such as a register, cache, and memory and the like that store data temporarily. Specific examples of the non-transitory computer-readable medium may include a CD, a DVD, a hard disc, a blue-ray disc, a USB, a memory card, and ROM and the like.

Each of the elements (e.g., module(s) or program(s)) according to the embodiments described above may be comprised of a single entity or multiple entities, and some corresponding sub elements described above may be omitted, or another sub element may be further included in the embodiments. Alternatively or additionally, some of the elements (e.g., modules or programs) may be integrated into one entity to perform functions performed by each corresponding element prior to the integration in an identical or similar way. Operations performed by a module, a program, or another element, according to the embodiments, may be executed sequentially, in parallel, repetitively, or heuristically, or at least part of the operations may be executed in a different order, may be omitted, or may add a different operation.

While the example embodiments of the disclosure are illustrated and described above, embodiments of the disclosure are not limited to the embodiments set forth herein, and certainly, various modifications thereof may be made by those skilled in the art to which the disclosure pertains, without departing from the scope of the subject matter of the disclosure claimed in the section of claims, and are not to be understood as separating from the technical spirit or prospect of the disclosure.

What is claimed is:

1. A robot comprising:
a camera;
memory storing instructions; and
at least one processor,
wherein the instructions, when executed by the at least one processor individually or collectively, cause the robot to:
obtain a first image using the camera;
obtain, based on the first image and a user command, a second image showing a result of the robot performing a task corresponding to the user command;
obtain action information of the robot for executing the user command by inputting the first image and the second image to a generative artificial intelligence (AI) model; and
perform a task corresponding to the user command based on the action information.

2. The robot as claimed in claim 1, wherein the instructions, when executed by the at least one processor individually or collectively, cause the robot to:
detect one or more objects in the first image; and
based on a user command for moving at least one object among the one or more objects being input, obtain the second image in which the at least one object is moved according to the user command.

3. The robot as claimed in claim 2, wherein the instructions, when executed by the at least one processor individually or collectively, cause the robot to obtain the second image by performing image inpainting at an initial position of the at least one object after the at least one object in the first image is moved.

4. The robot as claimed in claim 2, wherein the instructions, when executed by the at least one processor individually or collectively, cause the robot to, based on a user voice for performing the task being input, obtain the action information of the robot by inputting a text query corresponding to the user voice together with the first image and the second image to the generative AI model.

5. The robot as claimed in claim 4, wherein the instructions, when executed by the at least one processor individually or collectively, cause the robot to, based on the user voice for performing the task being input, generate a pre-set multi-step text query based on the user voice.

6. The robot as claimed in claim 2, wherein the generative AI model is trained to obtain action information comprising a sub action goal with respect to each object included in a start image based on a difference between the start image and a target image, and
wherein the instructions, when executed by the at least one processor individually or collectively, cause the robot to obtain the action information comprising a sub action goal corresponding to the at least one object, by inputting the first image and the second image to a generative AI model.

7. The robot as claimed in claim 6, wherein the instructions, when executed by the at least one processor individually or collectively, cause the robot to:
obtain first pose information of the at least one object in the first image; and
obtain second pose information comprising information on a specific pose taken by the robot to grip the at least one object or information on a position and direction of a grip.

8. The robot as claimed in claim 7, wherein the instructions, when executed by the at least one processor individually or collectively, cause the robot to obtain information on a sub action plan for moving a first object from among the at least one object based on a first sub action goal corresponding to the first object, the first pose information of the first object and the second pose information.

9. The robot as claimed in claim 8, wherein the instructions, when executed by the at least one processor individually or collectively, cause the robot to update first pose information of remaining objects from among the at least one object other than the first object after moving the first object based on the information on the sub action plan for moving the first object.

10. The robot as claimed in claim 1, wherein the user command comprises a user voice indicating information on the task, and
wherein the instructions, when executed by the at least one processor individually or collectively, cause the robot to:
obtain a text query corresponding to the user voice, and
obtain the second image by inputting the first image and the text query to a trained neural network model.

11. A method of controlling a robot, the method comprising:
obtaining a first image using a camera of the robot;
obtaining, based on the first image and a user command, a second image showing a result of the robot performing a task corresponding to the user command;
obtaining action information of the robot for executing a user command by inputting the first image and the second image to a generative artificial intelligence (AI) model; and
performing a task corresponding to the user command based on the action information.

12. The method as claimed in claim 11, the obtaining the second image comprises:
detecting one or more objects in the first image; and
based on a user command for moving at least one object among the one or more objects being input, obtaining the second image in which the at least one object is moved according to the user command.

13. The method as claimed in claim 12, wherein the obtaining the second image comprises performing image inpainting at an initial position of the at least one object after the at least one object in the first image is moved.

14. The method as claimed in claim 12, wherein the obtaining the action information comprises, based on a user voice for performing the task being input, obtaining the action information of the robot by inputting a text query corresponding to the user voice together with the first image and the second image to the generative AI model.

15. The method as claimed in claim 14, wherein the obtaining the action information comprises, based on the user voice for performing the task being input, generating a pre-set multi-step text query based on the user voice.

16. The method as claimed in claim 12, wherein the generative AI model is trained to obtain action information comprising a sub action goal with respect to each object in a start image, based on a difference between the start image and a target image, and
wherein the obtaining the action information comprises obtaining the action information comprising a sub action goal corresponding to the at least one object by inputting the first image and the second image to the generative AI model.

17. The method as claimed in claim 16, further comprising:
obtaining first pose information of the at least one object in the first image; and
obtaining second pose information comprising information on a specific pose taken by the robot to grip the at least one object or information on a position and direction of a grip.

18. The method as claimed in claim 17, wherein the obtaining action information comprises obtaining information on a sub action plan for moving a first object from among the at least one object based on a first sub action goal corresponding to the first object, the first pose information of the first object and the second pose information.

19. The method as claimed in claim 18, further comprising updating first pose information of remaining objects from among the at least one object other than the first object after moving the first object based on the information on the sub action plan for moving the first object.

20. The method as claimed in claim 11, wherein the user command comprises a user voice comprising information on the task, and
wherein the obtaining the second image comprises:
obtaining a text query corresponding to the user voice; and
obtaining the second image by inputting the first image and the text query to a trained neural network model.
